(19) United States
(12) Patent Application Publication
(10) Pub. No.: US 2023/0393004 A1
(43) Pub. Date: Dec. 7, 2023

(54) PRESSURE SENSOR AND METHOD FOR MANUFACTURING A PRESSURE SENSOR

(71) Applicant: Endress+Hauser SE+Co. KG, Maulburg (DE)

(72) Inventors: Elke Schmidt, Bad Säckingen (DE); Nils Ponath, Lörrach (DE); Andreas Rossberg, Bad Säckingen (DE); Anh Tuan Tham, Berlin (DE)

(21) Appl. No.: 18/044,042

(22) PCT Filed: Aug. 16, 2021
(86) PCT No.: PCT/EP2021/072738

§ 371 Date: Mar. 3, 2023

(30) Foreign Application Priority Data
Sep. 3, 2020 (DE) 10 2020 123 065.6

(51) Int. Cl. G01L 9/00

(52) U.S. Cl. CPC G01L 9/0075

(57) ABSTRACT

The present disclosure relates to a method for manufacturing a pressure sensor having a main body and a pressure-sensitive ceramic measurement membrane, wherein an outer edge of the measurement membrane is connected in a pressure-tight manner by an encircling joint to a surface of the main body facing the outer edge of the measurement membrane, wherein the joint includes a ternary active hard solder in eutectic composition: providing the main body, the measurement membrane and the active hard solder; positioning the active hard solder between the outer edge of the measurement membrane and the surface of the main body; heating the main body, the measurement membrane and the active hard solder to a joining temperature which essentially corresponds to a temperature of the eutectic point of the active hard solder.

The invention relates to a pressure sensor having a main body and a pressure-sensitive ceramic measurement membrane, wherein an outer edge of the measurement membrane is connected in a pressure-tight manner by means of an encircling joint, so as to enclose a pressure chamber, to a surface of the main body facing the outer edge of the measurement membrane. The invention also relates to a method for manufacturing a pressure sensor. In pressure measurement technology, absolute-pressure sensors, differential-pressure sensors and relative-pressure sensors are known. Absolute-pressure sensors determine the prevailing pressure absolutely, i.e., typically in relation to vacuum, while differential-pressure sensors determine the difference between two different pressures. In the case of relative-pressure sensors, the pressure to be measured is determined relative to a reference pressure, wherein the atmospheric pressure prevailing in the environment of the relative-pressure sensor serves as reference pressure.

A generic pressure sensor comprises a main body and a ceramic measurement membrane, which is connected in a pressure-tight manner to the main body by means of an active hard solder to form a measuring chamber. Furthermore, the pressure sensor generally comprises a converter for converting a pressure-dependent deformation of the measurement membrane into an electric primary signal, and a primary signal path which extends through the main body. The converter can be, for example, a capacitive or a resistive transducer. The primary signal path usually comprises at least one electrical feedthrough through the main body.

The encircling joint between the main body and the measurement membrane determines to a high degree the compressive strength and the leakproofness of the pressure sensor. Such joints are frequently produced by means of an active hard solder which comprises an active component which during active hard-soldering reacts with the ceramic of the measurement membrane and possibly with the ceramic of the main body. As a result of a reduction of the surface of the ceramic, a mechanically high-strength chemical bond is created between the ceramic and the active hard solder. Active hard solders offer the advantage that, due to the active component(s) contained therein, they are able to wet ceramic components and enable direct soldering of ceramic components without prior metallization of the ceramic. The active hard-soldering is carried out by heating the arrangement formed by the main body, the solder layer and the measurement membrane overall, under vacuum or protective gas, to a joining temperature corresponding to at least the melting temperature of the solder and holding it there over a longer period, in particular a period of 5 min to 15 min.

EP 0 490 807 B1 and EP 0 490 807 disclose a ternary active hard solder consisting of a zirconium/nickel alloy with titanium as active component, which can be used for manufacturing a pressure sensor.

For example, such an active hard solder with the composition Zr:Ni:Ti=63:22:15 at % is used to join a pressure sensor at a joining temperature of approximately 900° C. The melting temperature of the active hard solder in this composition is approximately 870° C. Due to the process, soldering typically takes place at a joining temperature which is above the melting temperature, for example about 30 K higher.

Known active hard solders have a coefficient of thermal expansion which is adapted to the coefficient of thermal expansion of main body and measurement membrane. However, the two coefficients of thermal expansion are not identical, which means that when the joint or pressure sensor cools down to room temperature from the joining temperature mechanical stresses will arise in the pressure sensor despite comparatively good matching. The greatest stresses in terms of magnitude form where the materials with the different coefficients of thermal expansion meet. Accordingly, the stresses are concentrated not only in a joint edge region facing the measurement membrane but also in a joint edge region facing the main body.

Whereas stresses in the joint edge region facing the main body have comparatively minor effects as regards measurement properties, stresses in the joint edge region facing the measurement membrane act directly on the pressure-dependent deformability of the measurement membrane and thus influence the measurement properties of the pressure sensor. These stresses, which are regularly variable as a function of the ambient temperature, create an additional temperature-dependence of the measurement results. Furthermore, they can cause a hysteresis of the measurement results that is dependent on the temporal profile of the ambient temperature and/or on the pressure to be measured, which results in a deterioration in the measurement accuracy achievable.

The object of the present invention is therefore to provide a pressure sensor in which stresses in the region of the joint are reduced, and to specify a corresponding method for manufacturing such a pressure sensor.

According to the invention, the object is achieved by a pressure sensor having a main body and a pressure-sensitive ceramic measurement membrane, wherein an outer edge of the measurement membrane is connected in a pressure-tight manner by means of an encircling joint, so as to enclose a pressure chamber, to a surface of the main body facing the outer edge of the measurement membrane, wherein the joint has a ternary active hard solder of eutectic composition, obtainable by a method comprising the following steps:
Providing the main body, the measurement membrane and the active hard solder,
Positioning the active hard solder between the outer edge of the measurement membrane and a surface of the main body facing the outer edge of the measurement membrane,
Heating the main body, the measurement membrane and the active hard solder to a joining temperature which essentially corresponds to a temperature of the eutectic point of the active hard solder, and
Cooling the pressure sensor.

In the eutectic composition, the active hard solder has a melting point that is lower than the respective melting points of the individual components of the active hard solder and of the lowest melting point of all possible compositions of the ternary active hard solder. Due to the reduced temperature at the melting point, the joint can be soldered at a reduced joining temperature, which in turn reduces stresses in the region of the joint compared to higher joining temperatures.

Furthermore, the use of the active hard solder in eutectic composition offers the advantage that the liquidus temperature is equal to the solidus temperature at the melting point of the eutectic and all phases of the active hard solder are in equilibrium. If the active hard solder is thus melted within the region of the temperature of the melting point and then cooled, a fine-crystalline and uniform solder joint will be formed. If the active hard solder in a non-eutectic composition is used, a substantially more inhomogeneous soldered joint would be obtained since, due to the existing solidification regions, different solid phases, which have different coefficients of thermal expansion, would be deposited so that intrinsic stresses would arise at the phase boundaries as a result. In the pressure sensor according to the invention, however, such stresses at phase boundaries are prevented or at least significantly reduced, since a homogeneous soldered joint is obtained.

In comparison to the prior art, stresses at the joining point are thus reduced in two ways: firstly by a lower joining temperature and secondly by the solidification of the active hard solder in eutectic composition. The eutectic composition of the active hard solder can be determined, for example, by chemical analysis of the joint. In one embodiment, the active hard solder consists of zirconium, nickel and titanium in an atomic ratio of Zr:Ni:Ti=47:26:27 at % with an error of ±5 at %. This ratio corresponds to the eutectic composition of the active hard solder of a Zr/Ni alloy with titanium as active component. Due to impurities in the raw materials, there may be slight deviations from the ideal eutectic composition of the active hard solder, which correspond to errors of up to ±5 at %, in particular errors of up to ±3 at %, up to ±2 at %, or up to ±1 at %.

In one possible embodiment, the joining temperature is approximately 770° C. In the ideal eutectic composition of the active hard solder, the temperature at the melting point is approximately 770° C. The joining temperature thus lies significantly below the previous joining temperatures of generic pressure sensors of approximately 900° C.

In order to take into account possible slight deviations from the ideal eutectic composition of the active hard solder and the conditions of the soldering system, soldering can be carried out within a range of the joining temperature which is somewhat higher than the actual melting temperature of the active hard solder. Soldering systems thus may not be set to a temperature but to a temperature range.

A further embodiment therefore provides that the joining temperature lies within a temperature range that is 2-10% above the melting point of the active hard solder.

An alternative embodiment includes the joining temperature lying within a temperature range that is 2-5% above the melting point of the active hard solder.

In a further embodiment, the joining temperature therefore lies within a temperature range of 770° C. to 860° C.

In an alternative embodiment, the joining temperature lies within a temperature range from 90° C. to 820° C. In order to take into account the problems and process conditions mentioned, soldering can be carried out at a joining temperature which is up to 30 K above the melting temperature of the active hard solder.

The main body is advantageously ceramic.

The measurement membrane and/or the main body are preferably made of corundum.

The object is further achieved according to the invention by a method for producing a pressure sensor with a main body and a pressure-sensitive ceramic measurement membrane, wherein an outer edge of the measurement membrane is connected in a pressure-tight manner by means of an encircling joint, so as to enclose a pressure chamber, to a surface of the main body facing the outer edge of the measurement membrane, wherein the joint has a ternary and eutectic active hard solder, wherein the method comprises:
Providing the main body, the measurement membrane and the active hard solder,
Positioning the active hard solder between the outer edge of the measurement membrane and a surface of the main body facing the outer edge of the measurement membrane,
Heating the main body, the measurement membrane and the active hard solder to a joining temperature which essentially corresponds to a temperature of the eutectic point of the active hard solder, and
Cooling the pressure sensor.

The method according to the invention makes it possible to produce a pressure sensor which has fewer stresses in the region of the joint compared to the prior art. This is achieved by the use of active hard solder in eutectic composition, as a result of which the melting temperature of the active hard solder is on one hand reduced, and on the other hand, a fine-crystalline and uniform joint is obtained during the cooling of the eutectic composition of the active hard solder.

In one embodiment, the active hard solder consists of zirconium, nickel and titanium in an atomic ratio of Zr:Ni:Ti=47:26:27 at % with an error of ±5 at %. In particular, the error may be up to ±3 at %, up to ±2 at %, or up to ±1 at %.

In one possible development, the joining temperature is approximately 770° C.

A further embodiment provides that the joining temperature lies within a temperature range that is 2-10% above the melting point of the active hard solder.

An alternative embodiment includes the joining temperature lying within a temperature range that is 2-5% above the melting point of the active hard solder.

In a further embodiment, the joining temperature therefore lies within a temperature range of 770° C. to 860° C.

In an alternative development, the joining temperature lies within a range of 790° C. to 820° C.

The main body is advantageously ceramic.

The measurement membrane and/or the main body are preferably made of corundum.

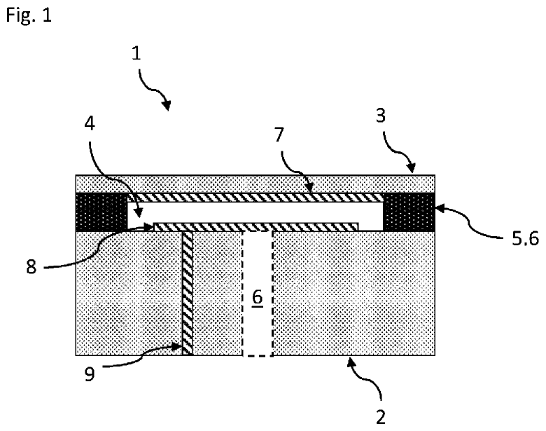

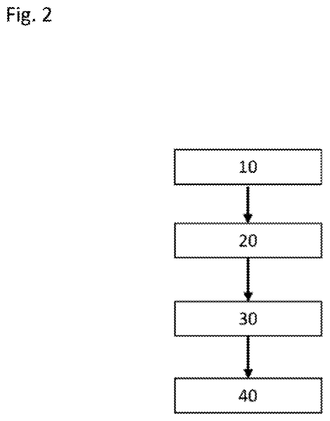

The invention will be explained in more detail below with reference to the following figures, FIGS. 1-2. In the figures:

FIG. 1: shows a schematic representation of a pressure sensor according to the invention.

FIG. 2: shows an exemplary embodiment of the method according to the invention.

The pressure sensor 1 according to the invention, as shown schematically in FIG. 1 in a sectional drawing, comprises a, for example ceramic, main body 2 and a ceramic measurement membrane 3. In the present example, both the main body 2 and the measurement membrane 3 are made of corundum. While enclosing a pressure chamber 4, an outer edge of the measurement membrane 3 is connected in a pressure-tight manner, by means of an encircling joint 5, to a surface of the main body 2 facing the outer edge of the measurement membrane 3. In order to apply a first pressure to the measurement membrane 3, a pressure supply line 10 optionally leads through the main body 2 into the pressure chamber 4. The second pressure is provided to the measurement membrane 3 at its surface facing away from the pressure chamber 4.

Pressure sensors of this type are manufactured and marketed by the applicant under the names Cerabar and Ceraphant.

The pressure sensor 1 further has, for example, a capacitive transducer which comprises a measuring electrode 7 on the surface of the measurement membrane 3 facing the pressure chamber 4 and a counter-electrode 8 on a surface of the main body 2 facing the pressure chamber 4. The counter-electrode 8 is contacted via an electrical conductor, which is designed as a contact pin 9, for example.

The joint 5 has a ternary active hard solder in eutectic composition, wherein a joining temperature of the joint 5 essentially corresponds to a temperature of a melting point of the active hard solder 6. The active hard solder 6 can consist, for example, of zirconium, nickel and titanium in an atomic ratio of Zr:Ni:Ti=47:26:27 at % with an error of ±5 at %; in particular the ratio of Zr:Ni:Ti=47:26:27 at % can have an error of up to ±3 at %, up to ±2 at %, or up to ±1 at %.

For example, the joining temperature of the pressure sensor is approximately 770° C. The joining temperature can optionally lie within a temperature range which is 2-10% or in particular 2-5% above the melting point of the active hard solder 6. Alternatively, the joining temperature can lie within a temperature range of 770° C. to 860° C. or in particular within a range of 790° C. to 820° C.

FIG. 2 shows an exemplary embodiment of the method according to the invention for manufacturing a pressure sensor 1 having a main body 2 and a pressure-sensitive ceramic measurement membrane 3. The pressure sensor according to the invention from FIG. 1 is obtainable by a method shown in FIG. 2. While enclosing a pressure chamber 4, an outer edge of the measurement membrane 3 is connected in a pressure-tight manner, by means of an encircling joint 5, to a surface of the main body 2 facing the outer edge of the measurement membrane 3, wherein the joint 5 has a ternary and eutectic active hard solder 6. In a first step 10 of the method according to the invention, the main body 2, the measurement membrane 3 and the active hard solder 6 are first provided and in a second step 20 positioned such that the active hard solder 6 is arranged between the outer edge of the measurement membrane 3 and a surface of the main body 2 facing the outer edge of the measurement membrane 3. In a third step 30, the main body 2, the measurement membrane 3 and the active hard solder 6 are heated up to a joining temperature which essentially corresponds to a temperature of the eutectic point of the active hard solder 6. The joining temperature is maintained for a defined period of time before the arrangement of measurement membrane 3 and main body 2 is cooled in a fourth step 40. In this way, a pressure sensor with a homogeneous joint between the measurement membrane 3 and the main body 2 is obtained.

### LIST OF REFERENCE SIGNS

1 Pressure sensor
2 Main body
3 Measurement membrane
4 Pressure chamber
5 Joint
6 Active hard solder
7 Measuring electrode
8 Counter-electrode
9 Contact pin
10 Pressure supply line

1-10. (canceled)

11. A pressure sensor comprising a main body and a pressure-sensitive ceramic measurement membrane, wherein an outer edge of the measurement membrane is connected in a pressure-tight manner by an encircling joint to a surface of the main body facing the outer edge of the measurement membrane so as to enclose a pressure chamber, wherein the joint includes a ternary active hard solder in eutectic composition, the pressure sensor fabricated by a method comprising:
providing the main body, the measurement membrane and the active hard solder;
positioning the active hard solder between the outer edge of the measurement membrane and the surface of the main body facing the outer edge of the measurement membrane;
heating the main body, the measurement membrane and the active hard solder to a joining temperature, which essentially corresponds to a temperature of the eutectic point of the active hard solder; and
cooling the pressure sensor below the joining temperature.

12. The pressure sensor of claim 11, wherein the active hard solder consists essentially of zirconium, nickel, and titanium in an atomic ratio of Zr:Ni:Ti=47:26:27 atomic percentage (at %) within an error of ±5 at %.

13. The pressure sensor of claim 11, wherein the joining temperature is approximately 770° C.

14. The pressure sensor of claim 11, wherein the joining temperature is within a temperature range that is 2-10% above a melting point of the active hard solder.

15. The pressure sensor of claim 11, wherein the joining temperature is within a temperature range that is 2-5% above a melting point of the active hard solder.

16. The pressure sensor of claim 11, wherein the joining temperature is within a temperature range of 770° C. to 860° C.

17. The pressure sensor of claim 11, wherein the joining temperature is within a temperature range of 790° C. to 820° C.

18. The pressure sensor of claim 11, wherein the main body is ceramic.

19. The pressure sensor of claim 11, wherein the measurement membrane and/or the main body are made of corundum.

20. A method for fabricating a pressure sensor that comprises a main body and a pressure-sensitive ceramic measurement membrane, wherein an outer edge of the measurement membrane is connected in a pressure-tight manner by an encircling joint to a surface of the main body facing the outer edge of the measurement membrane so as to enclose a pressure chamber, wherein the joint includes a ternary and eutectic active hard solder, the method comprising:
providing the main body, the measurement membrane and the active hard solder;
positioning the active hard solder between the outer edge of the measurement membrane and the surface of the main body facing the outer edge of the measurement membrane;
heating the main body, the measurement membrane and the active hard solder to a joining temperature which essentially corresponds to a temperature of the eutectic point of the active hard solder; and
cooling the pressure sensor below the joining temperature.

21. The method of claim 20, wherein the active hard solder consists essentially of zirconium, nickel, and titanium in an atomic ratio of Zr:Ni:Ti=47:26:27 atomic percentage (at %) within an error of ±5 at %.

22. The method of claim 20, wherein the joining temperature is approximately 770° C.

23. The method of claim 20, wherein the joining temperature is within a temperature range that is 2-10% above a melting point of the active hard solder.

24. The method of claim 20, wherein the joining temperature is within a temperature range that is 2-5% above a melting point of the active hard solder.

25. The method of claim 20, wherein the joining temperature is within a temperature range of 770° C. to 860° C.

26. The method of claim 20, wherein the joining temperature is within a temperature range of 790° C. to 820° C.

27. The method of claim 20, wherein the main body is ceramic.

28. The method of claim 20, wherein the measurement membrane and/or the main body are made of corundum.
